(19) United States
(12) Patent Application Publication
(10) Pub. No.: US 2004/0220325 A1
(43) Pub. Date: Nov. 4, 2004

(54) Fiber-polypropylene resin composite and its pellet, and fiber-reinforced resin articles made therefrom

(75) Inventors: Katsuhisa Kitano, Ichihara-shi (JP); Kenji Atarashi, Bartlesville, OK (US); Hiroyuki Tanimura, Sodegaura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/768,663

(22) Filed: Feb. 2, 2004

(30) Foreign Application Priority Data
Feb. 7, 2003 (JP) 2003-030545

(51) Int. Cl. C08L 1/00

(52) U.S. Cl. 524/543

(57) ABSTRACT

A fiber-polypropylene resin composite is disclosed which includes:

fiber having a weight average length of 2-100 mm; and

a propylene-based resin comprising a propylene-based random copolymer obtained by polymerization of propylene and a monomer or monomers selected from the group consisting of ethylene and α-olefin, the propylene-based resin having a content of the polymerized monomer units derived from the monomers belonging to the group consisting of ethylene and α-olefin of 0.1-3% by weight; or a modified propylene-based resin obtained by modification of the propylene-based resin with an unsaturated carboxylic acid or its derivative.

### BACKGROUND OF THE INVENTION

1. Field of the Invention

The present invention relates to fiber-polypropylene resin composites, to their pellets, and to fiber-reinforced resin articles obtained by using them. More particularly, the invention relates to fiber-reinforced resin articles superior in creep characteristics and to fiber-polypropylene resin composites and their pellets suitable as the raw materials of the fiber-reinforced resin articles.

2. Description of the Related Art

As an approach for improving the mechanical strength of polypropylene resin such as rigidity and impact strength, it is conventionally known to incorporate filler, glass fiber or the like into the resin.

For example, Japanese Patent Laid-Open No. 3-121146 discloses a polyolefin resin composition for long-fiber-reinforcing molding which contains polyolefin, a modified polyolefin polymer and reinforcing fiber having a length of 2 mm or more.

Japanese Patent Laid-Open No. 4-298553 discloses a glass fiber-reinforced polyolefin resin composition comprising polypropylene resin, low density polyethylene, glass fiber and modified polyolefin. This document also discloses that a block copolymer of propylene and ethylene can be used as the polypropylene resin.

Japanese Patent Laid-Open No. 9-183869 discloses a long-fiber-reinforced polyolefin resin pellet obtained by impregnating a continuous reinforcing glass fiber bundle with polyolefin resin while pulling the fiber bundle. This document also discloses that propylene homopolymers and random or block copolymers of propylene and ethylene can be used as the polyolefin resin.

However, the long-fiber-reinforced resin composition and its pellet as well as articles made from the resin composition or pellet are required to be improved further with respect to their creep characteristics.

### SUMMARY OF THE INVENTION

The object of the present invention is to provide fiber-reinforced resin articles superior in creep characteristic, and to provide fiber-polypropylene resin composites and pellets thereof which are superior in creep characteristic and suitable as the raw material of said fiber-reinforced resin articles.

The present inventors studied diligently while taking such circumstances into consideration and, as a result, they have accomplished the inventions outlined below.

[1] A fiber-polypropylene resin composite comprising 20-95% by weight of component (A) defined below and 5-80% by weight of component (B) which is fiber having a weight average length of 2-100 mm, provided that said contents of components (A) and (B) are based on the combined weight of components (A) and (B):

component (A): a propylene-based resin that comprises component (A-1) which is a propylene-based random copolymer obtained by polymerization of propylene and at least one kind of monomer selected from the group consisting of ethylene and α-olefin, the propylene-based resin having a content of the polymerized monomer units derived from the monomers belonging to the group consisting of ethylene and α-olefin of 0.1-3% by weight; or a modified propylene-based resin obtained by modification of the propylene-based resin with an unsaturated carboxylic acid or its derivative, provided that said content of the polymerized monomer units is based on the weight of the whole polymerized monomer units contained in the propylene-based resin.

In the following description, this composite is sometimes referred to as a “first composite.”

[2] A fiber-polypropylene resin composite comprising resin (D) defined below and component (B) which is fiber having a weight average length of 2-100 mm, provided that the amount of component (B) is 5-400 parts by weight based on 100 parts by weight of resin (D):

resin (D): a resin consisting of 60-99.9% by weight of component (A′) defined below and 0.1-40% by weight of component (C) which is a modified polyolefin, provided that said contents of components (A′) and (C) are based on the weight of the resin and the sum of the contents is 100% by weight;

component (A′): a propylene-based resin that comprises component (A-1) which is a propylene-based random copolymer obtained by polymerization of propylene and at least one kind of monomer selected from the group consisting of ethylene and α-olefin, the propylene-based resin having a content of the polymerized monomer units derived from the monomers belonging to the group consisting of ethylene and α-olefin of 0.1-3% by weight, provided that said content of the polymerized monomer units is based on the weight of the whole polymerized monomer units contained in the propylene-based resin.

In the following description, this composite is sometimes referred to as a “second composite.”

[3] A pellet made of the fiber-polypropylene resin composite referred to in item [1] or [2] above, wherein the individual fibers constituting component (B) are arranged in parallel to one another.

[4] A shaped article obtained by melt-kneading the fiber-polypropylene resin composite referred to in item [1] or [2] above and then shaping the resulting kneaded material, wherein the fibers derived from component (B) have a weight average length of at least 1 mm.

According to the present invention, a fiber-reinforced resin article being superior in creep characteristic, in other words, showing a sufficiently long rupture time in tensile creep measurement can be obtained. In addition, a fiber-polypropylene resin composite and its pellets which are suitable as the raw material of that article can be obtained.

### BRIEF DESCRIPTION OF THE DRAWING

FIG. 1 shows the shape of the samples used in the tensile creep measurements.

### DETAILED DESCRIPTION OF THE INVENTION

The propylene-based resin, which is contained in the first composite as component (A) or is employed as a raw material of component (A) and which is contained in the second composite as component (A′), is a resin that comprises component (A-1) which is a propylene-based random copolymer obtained by polymerization of propylene and at least one kind of monomer selected from the group consisting of ethylene and α-olefin.

The propylene-based random copolymer, which is component (A-1), is a copolymer which is obtained by polymerization of propylene and at least one kind of monomer selected from the group consisting of ethylene and α-olefin. Specific examples thereof include propylene-ethylene random copolymers, propylene-α-olefin random copolymers, and propylene-ethylene-α-olefin random copolymers.

The propylene-based resin may either be constituted only of the above-mentioned propylene-based random copolymer or be a mixture made up of the propylene-based random copolymer and a propylene homopolymer, which is henceforth referred to as component (A-2). In the case where the propylene-based resin is a mixture of components (A-1) and (A-2), the weight ratio of component (A-1) in the mixture is usually not less than 10% by weight but less than 100% by weight, preferably not less than 20% by weight but less than 100% by weight, and more preferably not less than 25% by weight but less than 100% by weight. A concrete weight ratio of component (A-1) is determined appropriately depending on the copolymerization composition of the propylene-based random copolymer (component (A-1)), that is, the ratio of each kind of polymerized monomer units in the propylene-based random copolymer, and on the content of the polymerized monomer units derived from the monomers belonging to the group consisting of ethylene and α-olefin which should be contained in the desired propylene-based resin.

The content of the polymerized monomer units derived from the monomers belonging to the group consisting of ethylene and α-olefin contained in the propylene-based resin is 0.1-3% by weight. The content of the polymerized monomer units referred to herein is an amount based on the weight of the whole polymerized monomer units contained in the propylene-based resin.

In the case where the propylene-based resin is consituted only of component (A-1), namely, a propylene-baed random copolymer, the component (A-1) is a random copolymer containing the polymerized monomer units derived from the monomers belonging to the group consisting of ethylene and α-olefin in a content of 0.1-3% by weight. From the viewpoints of the rigidity, impact strength, creep characteristic, and so on of fiber-reinforced resin articles, the content of the polymerized monomer units derived from the monomers belonging to the group consisting of ethylene and α-olefin contained in component (A-1) is preferably 0.2-2.5% by weight, and more preferably 0.4-2% by weight.

The content of the polymerized monomer units derived from the monomers belonging to the group consisting of ethylene and α-olefin contained in component (A-1) is determined by use of the IR method or the NMR method described in “New Edition Macromolecule Handbook” edited by The Chemical Society of Japan, The Meeting of Macromolecule Analysis, published by Kinokuniya Co., Ltd. (1995).

On the other hand, when the propylene-based resin is a mixture of a propylene-based random copolymer, which is component (A-1), and a propylene homopolymer, which is component (A-2), a propylene-based random copolymer containing the polymerized monomer units derived from the monomers belonging to the group consisting of ethylene and α-olefin in a content of more than 0.1% by weight but not more than 5% by weight is usually employed as component (A-1). In such an occasion, the amounts of components (A-1) and (A-2) are determined in such a way that the content of the polymerized monomer units derived from the monomers belonging to the group consisting of ethylene and α-olefin contained in the propylene-based resin becomes 0.1-3% by weight. From the viewpoints of the rigidity, impact strength, creep characteristic, and so on of fiber-reinforced resin articles, the content of the polymerized monomer units is preferably 0.2-2.5% by weight, and more preferably 0.4-2% by weight.

Also in the case where the propylene-based resin is a mixture of components (A-1) and (A-2), the content of the polymerized monomer units derived from the monomers belonging to the group consisting of ethylene and α-olefin is determined by the IR method or the NMR method described in “New Edition Macromolecule Handbook” edited by The Chemical Society of Japan, The Meeting of Macromolecule Analysis, published by Kinokuniya Co., Ltd. (1995).

The α-olefin in the propylene-based random copolymer (component (A-1)) is an α-olefin having 4-20 carbon atoms and examples thereof include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, 1-dodecene and the like. Preferred are 1-butene, 1-pentene, 1-hexene and 1-octene.

From the viewpoints of the dispersibility of fibers in fiber-reinforced resin articles and the external appearance and impact strength of fiber-reinforced resin articles, the melt flowrate (henceforth, abbreviated as MFR) of the propylene-based random copolymer (component (A-1)) is preferably 5-150 g/10 minutes, and more preferably 10-100 g/10 minutes. The MFR is determined at 230° C. at a load of 21.2 N in accordance with ASTM D1238.

From the viewpoints of the dispersibility of fibers in fiber-reinforced resin articles and the external appearance and flexural strength of fiber-reinforced resin articles, the MFR of the propylene homopolymer (component (A-2)) is preferably 5-300 g/10 minutes, more preferably 5-150 g/10 minutes, and particularly preferably 10-100 g/10 minutes. The MFR is determined at 230° C. at a load of 21.2 N in accordance with ASTM D1238.

The modified propylene-based resin is prepared by melt-kneading described in “Practical Design of Polymer Alloy” Fumio IDE, Kogyo Chosakai Publishing Co. (1996), Prog. Polym. Sci., 24, 81-142 (1999), Japanese Patent Laid-Open No. 2002-308947, and so on.

Examples of the unsaturated carboxylic acids for use in the preparation of the modified polypropylene resin include maleic acid, fumaric acid, itaconic acid, acrylic acid, methacrylic acid and the like. The derivatives of the unsaturated carboxylic acids may be, for example, acid anhydrides, ester compounds, amide compounds, imide compounds, metal salts and the like derived from the unsaturated carboxylic acids. Specific examples thereof include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, monoethyl maleate, diethyl maleate, monomethyl fumarate, dimethyl fumarate, acrylamide, methacrylamide, maleic acid monoamide, maleic acid diamide, fumaric acid monoamide, maleimide, N-butylmaleimide, sodium methacrylate and the like. Further, there can be used compounds which form unsaturated carboxylic acids by undergoing dehydration in the step of graft polymerization to polyolefin, such as citric acid and malic acid.

Preferred as the unsaturated carboxylic acid or its derivative are glycidyl acrylate, glycidyl methacrylate and maleic anhydride.

From the viewpoints of the mechanical strength, such as impact strength, fatigue characteristics and rigidity, of fiber-reinforced resin articles, what is preferred as the modified propylene-based resin is a modified polypropylene resin containing polymerized monomer units derived from an unsaturated carboxylic acid and its derivative in an amount of 0.01-10% by weight, more preferably 0.05-10% by weight, and especially preferably 0.1-5% by weight.

Component (B) in the present invention is fiber having a weight average length of 2-100 mm. From the viewpoints of the mechanical strength such as rigidity and impact strength of fiber-reinforced resin articles and ease of production and molding of fiber-resin composites, the weight average length of the fiber, which is component (B), is preferably 3-50 mm. The weight average length of the fiber can be determined by the method described in Japanese Patent Laid-Open No. 2002-5924.

The fiber used as component (B) may be either inorganic fiber, organic fiber and natural fiber. Examples thereof include glass fiber, carbon fiber, metal fiber, aromatic polyamide fiber, kenaf fiber, bamboo fiber, polyester fiber, nylon fiber, jute fiber, cellulose fiber, ramie fiber and the like. Glass fiber is preferred.

The fiber used as component (B) may be in the form of fibers bound with a binder. Examples of available binders include polyolefin resin, polyurethane resin, polyester resin, acrylic resin, epoxy resin, starch, vegetable oil and the like. Moreover, the binder of the fiber used as component (B) may contain acid-modified polyolefin resin, a surface treating agent and a lubricant such as paraffin wax.

The fiber used as component (B) may be treated with a surface treating agent for the purpose of improving the wettability, adhesiveness and the like. Examples of the fiber treating agent include silane-based coupling agents, titanate-based coupling agents, aluminum-containing coupling agents, chromium-containing coupling agents, zirconium-containing coupling agents, borane-containing coupling agents and the like. Silane-based coupling agents and titanate-based coupling agents are preferable. Silane-based coupling agents are especially preferable.

Examples of the silane-based coupling agents include triethoxysilane, vinyltris(β-methoxyethoxy)silane, γ-methacryloxypropyltrimethoxysilane, γ-glycidoxypropyltrimethoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, γ-chloropropyltrimethoxysilane and the like. Preferred are aminosilanes such as γ-aminopropyltriethoxysilane and N-β-(aminoethyl)-γ-aminopropyltrimethoxysilane.

The method for treating the fiber with a surface treatment agent may be methods conventionally employed, for example, the aqueous solution method, the organic solvent method and the spray method.

The second composite of the present invention is a fiber-polypropylene resin composite comprising resin (D) defined below and component (B), which is fiber having a weight average length of 2-100 mm:

resin (D): a resin consisting of 60-99.9% by weight of component (A′) defined below and 0.1-40% by weight of component (C) which is a modified polyolefin, provided that said contents of components (A′) and (C) are based on the weight of the resin and the sum of the contents is 100% by weight:

component (A′): a propylene-based resin that comprises component (A-1) which is the propylene-based random copolymer previously mentioned, the propylene-based resin having a content of the polymerized monomer units derived from the monomers belonging to the group consisting of ethylene and α-olefin of 0.1-3% by weight, provided that said content of the polymerized monomer units is based on the weight of the whole polymerized monomer units contained in the propylene-based resin.

The modified polyolefin resin, which is component (C), is selected from any one of the following resins (1)-(4):

(1) a modified polyolefin resin obtained by graft polymerizing an unsaturated carboxylic acid and/or its derivative to an olefin homopolymer,

(2) a modified polyolefin resin obtained by graft polymerizing an unsaturated carboxylic acid and/or its derivative to a copolymer of at least two kinds of olefins,

(3) a modified polyolefin resin obtained by graft polymerizing an unsaturated carboxylic acid and/or its derivative to a block copolymer obtained by homopolymerization of olefin followed by copolymerization of at least two kinds of olefins, and

(4) a modified polyolefin resin obtained by random or block copolymerization of at least one kind of olefin and an unsaturated carboxylic acid and/or its derivative.

In the production of the modified polyolefin resin, various methods, e.g. the methods described in “Practical Design of Polymer Alloy” Fumio IDE, Kogyo Chosakai Publishing Co. (1996), Prog. Polym. Sci., 24, 81-142(1999), Japanese Patent Laid-Open No. 2002-308947, and so on, may be employed. Concretely, any of the solution method, the bulk method and the melt-kneading method may be used. These methods may be employed in combination.

Examples of the unsaturated carboxylic acids for use in the preparation of the modified polyolefin resin include maleic acid, fumaric acid, itaconic acid, acrylic, and methacrylic acid and the like. The derivatives of the unsaturated carboxylic acids may be, for example, acid anhydrides, ester compounds, amide compounds, imide compounds, metal salts and the like derived from the unsaturated carboxylic acids. Specific examples thereof include maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, monoethyl maleate, diethyl maleate, monomethyl fumarate, dimethyl fumarate, acrylamide, methacrylamide, maleic acid monoamide, maleic acid diamide, fumaric acid monoamide, maleimide, N-butylmaleimide, sodium methacrylate and the like. Further, there can be used compounds which form unsaturated carboxylic acids by undergoing dehydration in the step of graft polymerization to polyolefin, such as citric acid and malic acid.

Examples of preferable unsaturated carboxylic acids and their derivatives include glycidyl acrylate, glycidyl methacrylate and maleic anhydride.

Examples of preferable component (C) include:

(1) a modified polyolefin resin obtained by graft polymerizing maleic anhydride to a polyolefin resin made up mainly of units derived from at least one kind of monomers selected from ethylene and propylene; and

(2) a modified polyolefin resin obtained by copolymerizing glycidyl methacrylate or maleic anhydride with olefin composed mainly of at least one kind of monomers selected from ethylene and propylene.

From the viewpoints of the mechanical strength, such as impact strength, fatigue characteristics and rigidity, of fiber-reinforced resin articles, preferred as the modified polyolefin resin (component (C)) is a modified polyolefin resin containing polymerized monomer units derived from unsaturated carboxylic acid and/or its derivative in an amount of 0.1-10% by weight. In particular, in the case of a modified polyolefin resin obtained by random or block copolymerization using an unsaturated carboxylic acid and/or its derivative, the content of the polymerized monomer units derived from the unsaturated carboxylic acid and/or its derivative is preferably 3-10% by weight. On the other hand, in the case of a modified polyolefin resin obtained by graft polymerization, the content of the polymerized monomer units derived from the unsaturated carboxylic acid and/or its derivative is preferably 0.1-10% by weight.

The incorporation proportions of components (A) and (B) in the first composite of the present invention are 20-95% by weight and 5-80% by weight, respectively. Both the amount of component (A) and that of component (B) referred to herein are based on the combined amount of components (A) and (B).

From the viewpoints of the mechanical strength, such as rigidity and impact strength, of fiber-reinforced articles and ease of production or molding of fiber-resin composites, the incorporation proportion of component (A) and that of component (B) are preferably 30-90% by weight and 10-70% by weight, respectively.

In the second composite of the present invention, the incorporation proportions of component (A′) and (C) in resin (D) are 60-99.9% by weight and 0.1-40% by weight, respectively. Both the amount of component (A′) and that of component (C) referred to herein are based on the weight of the whole resin (D) and the sum of the amounts of components (A′) and (C) is 100% by weight.

From the viewpoints of the mechanical strength, such as rigidity and impact strength, and the fatigue characteristics of fiber-reinforced resin articles, the incorporation proportions of component (A′) and (C) in resin (D) are preferably 70-99.5% by weight and 0.5-30% by weight, respectively, and more preferably 80-99% by weight and 1-20% by weight, respectively.

From the viewpoints of the mechanical strength, such as rigidity and impact strength, of fiber-reinforced resin articles and ease of production or molding of fiber-resin composites, the content of component (B) in the second composite is 5-400 parts by weigh, preferably 10-300 parts by weight, based on 100 parts by weight of resin (D).

The first and second composites of the present invention may contain one or more kinds of resins such as a block copolymer obtained by homopolymerization of olefin followed by copolymerization of at least two kinds of olefins, e.g. a propylene block copolymer obtained by homopolymerization of propylene followed by polymerization to ethylene-propylene copolymer portions, and other polyolefin resins. The composites may also contain nucleating agents, crystallization accelerators, and so on.

Moreover, the composites may also contain additives commonly added to polyolefin resins, for example, stabilizers, e.g. antioxidants, heat stabilizers, neutralizing agents and ultraviolet absorbers, foam inhibitors, flame retarders, flame retarding aids, dispersing agents, antistatic agents, lubricants, antiblocking agents, e.g. silica, colorants, e.g. dyestuffs and pigments, and plasticizers.

Furthermore, tabular or granular inorganic compounds such as glass flakes, mica, glass powder, glass beads, talc, clay, alumina, carbon black and wollastonite, or whiskers may be incorporated in the composites.

In the productions of fiber-polypropylene resin compositions of the present invention, pultrusion is preferably applied.

The pultrusion is basically a method in which a continuous fiber bundle is impregnated with resin while being pulled and examples thereof include:

(1) a method in which a fiber bundle is impregnated with resin by passing the fiber bundle through an impregnation bath containing an emulsion, suspension or solution of the resin;

(2) a method in which a fiber bundle is impregnated with resin in such a manner that the resin is attached to the fiber bundle by spraying a powder of the resin to the fiber bundle or passing the fiber bundle through a bath containing the powder and then the resin is melted; and

(3) a method in which a fiber bundle is impregnated with resin by passing the fiber bundle in a crosshead and simultaneously supplying the resin to the crosshead from an extruder or the like. Preferred is the method (3) using a crosshead. Particularly preferred is a method using a crosshead of the type disclosed in Japanese Patent Laid-Open No. 3-272830.

In the pultrusion method, the impregnation of the fiber bundle with resin can be done either in a single step or in two or more separate steps.

Examples of the form of the fiber-polypropylene resin composite of the present invention include a strand, a sheet, a plate, and a pellet obtained by cutting any of the foregoing into a length within the range of 2-100 mm. In the pellet of the fiber-polypropylene resin composite, individual fibers of component (B) are preferably arranged in parallel to one another. From the viewpoint of ease of application to injection molding, preferred are pellets 2-50 mm in length. Particularly preferred are pellets in which individual fibers of component (B) are arranged in parallel to one another and the length of the composite in the orientation direction of the fibers and the length of the fibers are equal and are within the range of 2-50 mm.

The fiber-polypropylene resin composite or its pellet of the present invention may be fabricated into fiber-reinforced resin articles via its melt-kneading and the molding of the resulting melt-kneaded material into a desired shape. In the fiber-reinforced resin article of the present invention, the fibers derived from component (B) have a weight average length of not less than 1 mm, and preferably not less than 1 mm and not more than 100 mm. The method for shaping the melt-kneaded material is not limited particularly. For example, injection molding is applied. The fiber-reinforced resin article of the present invention is superior in mechanical strength because it contains fiber having a weight average length of 1 mm or more. In the production of fiber-reinforced resin articles from the fiber-polypropylene resin composite or its pellet of the present invention, the melt-kneading conditions and molding conditions can be determined based on common knowledge of those skilled in the art. The weight average length of the fiber in an article can be measured by the method described in Japanese Patent Laid-Open No. 2002-5924. During the melt-kneading carried out in the production of fiber-reinforced resin articles using the fiber-polypropylene resin composite or its pellet, additional resin materials or additives may be incorporated into the composite or its pellet.

### EXAMPLES

The present invention is illustrated below by reference to Examples and Comparative Examples. The invention, however, is not limited to the Examples.

The method for producing the samples for evaluations used in Examples or Comparative Examples is described below.

(1) Method for Preparing Long-Fiber-Containing Resin Pellet

A long-fiber-reinforced resin pellet was prepared by the method described in Japanese Patent Laid-Open No. 3-121146 at an impregnation temperature of 270° C. and a take-up rate of 13 m/minute. The diameter of the glass fiber used was 16 μm.

(2) Method for Preparing Samples for Evaluations

A sample for evaluation was prepared by injection molding under the conditions shown below by means of the molding machine specified below using the long-fiber-containing resin pellet obtained in the above (1).

Molding Machine (manufactured by The Japan Steel Works, Ltd.)

Clamping force: 150 ton

Screw: Screw with a deep channel

Screw diameter: 46 mm

Screw L/D: 20.3

Molding Conditions

Cylinder temperature: 250° C.

Mold temperature: 50° C.

Back pressure: 0 MPa

The evaluation methods used in Examples and Comparative Examples are described below.

(1) Flexural Strength (Unit: MPa)

The flexural strength was measured in accordance with ASTM D790 under the following conditions.

Measuring temperature: 23° C.

Sample thickness: 6.4 mm

Span: 100 mm

Tensile rate: 2 mm/min

(2) Tensile Strength (Unit: MPa)

The tensile strength was measured in accordance with ASTM D638 under the following conditions.

Measuring temperature: 23° C.

Sample thickness: 3.2 mm

Tensile rate: 10 mm/min

(3) IZOD Impact Strength (Unit: KJ/m²)

The IZOD impact strength was measured in accordance with ASTM D256 under the following conditions.

Measuring temperature: 23° C.

Sample thickness: 6.4 mm (with a V-shaped notch)

(4) Content of Polymerized Comonomer Units (Unit: % By Weight)

The content of the polymerized monomer units in a resin was determined by the IR method described in “New Edition Macromolecule Handbook” edited by The Chemical Society of Japan, The Meeting of Macromolecule Analysis, published by Kinokuniya Co., Ltd. (1995).

(5) Rupture Time in Tensile Creep Measurement (Unit: Hour)

The rupture time in the tensile creep measurement was measured under the following conditions.

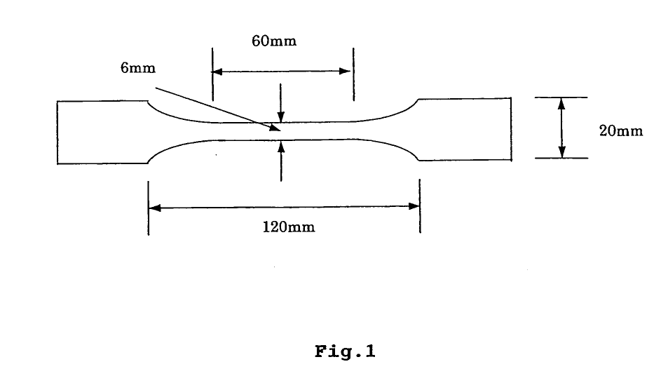

In the measurement, samples with a shape shown in FIG. 1 were used.

Measuring apparatus: creep tester, model CP-6P-100, manufactured by Baldwin Co., Ltd.

Temperature: 80° C.

Sample thickness: 2.5 mm

Load stress: 47 MPa

Distance between chucks: 100 mm

### Example 1

Using a propylene-based resin, fiber and a modified polyolefin resin, fiber-containing resin pellets having a composition shown in Table 1 were prepared by the method described in JP-A-3-121146. The content of the fiber in the pellets were 40% by weight and the pellets were 9 mm long. From the resulting pellets samples for measurement of physical properties shown in FIG. 1 were prepared by injection molding. The tensile strength, flexural strength, IZOD impact strength and rupture time in tensile creep measurement of the samples are shown in Table 1.

The propylene-based resin used was a propylene-ethylene random copolymer (ethylene content=1.0% by weight, MFR=25 g/10 minutes). On the other hand, the modified polyolefin resin was a maleic anhydride-modified polypropylene resin (MFR=60 g/10 minutes, amount of maleic anhydride grafted=0.6% by weight). This was prepared by adding 1.0 part by weight of maleic anhydride, 0.50 part by weight of dicetyl peroxydicarbonate, 0.15 part by weight of 1,3-bis(tert-butylperoxydiisopropyl)benzene, 0.05 part by weight of calcium stearate and 0.3 part by weight of an antioxidant tetrakis[methylene-3-(3,5-di-tert-butyl-4-hydroxyphenyl) propionate]methane to 100 parts by weight of an ethylene-propylene block copolymer (intrinsic viscosity [η]=2.8 (dl/g), ethylene-propylene copolymer portion content=21% by weight), preliminarily mixing the mixture fully in a Henschel mixer, feeding the resulting mixture to a single screw extruder, and melt-kneading it therein. The extruder was a single screw extuder EXT-90 (L/D=36, cylinder diameter=90 mm) manufactured by Isuzu Kakoki, Co., Ltd. The extruder was set at 180° C. in its upstream half section and at 250° C. in its downstream half section. The revolution speed of the screw was 133 rpm.

### Comparative Example 1

The preparation of fiber-containing resin pellets, the injection molding and the evaluation of physical properties were conducted in the same manner as Example 1 except changing the propylene-based resin used in Example 1 to a propylene-ethylene random copolymer (ethylene content=4.0% by weight, MFR=25 g/10 minutes).

### Comparative Example 2

The preparation of fiber-containing resin pellets, the injection molding and the evaluation of physical properties were conducted in the same manner as Example 1 except changing the propylene-based resin used in Example 1 to a propylene homopolymer (ethylene content=0% by weight, MFR=25 g/10 minutes).

TABLE 1

| | | Comparative | Comparative |
|---|---|---|---|
| | Example 1 | Example 1 | Example 2 |
| Propylene-based resin | | | |
| Kind of resin | a-1 | a-2 | a-3 |
| Amount (part(s) by weight) | 58 | 58 | 58 |
| Fiber | | | |
| Kind of fiber | b-1 | b-1 | b-1 |
| Amount (part(s) by weight) | 40 | 40 | 40 |
| Modified polyolefin resin | | | |
| Kind of resin | c-1 | c-1 | c-1 |
| Amount (part(s) by weight) | 2 | 2 | 2 |
| Evaluations | | | |
| Content of polymerized | 1.0 | 4.0 | 0.0 |
| comonomer units in | | | |
| propylene-based resin (% by | | | |
| weight) | | | |
| Flexural strength (MPa) | 153 | 137 | 161 |
| Tensile strength (MPa) | 160 | 150 | 170 |
| IZOD impact strength (KJ/m²) | 29 | 31 | 30 |
| Rupture time in tensile creep | 270 | 120 | 80 |
| measurement (hour) | | | |

a-1: Propylene-ethylene random copolymer (ethylene content = 1.0% by weight, MFR = 25 g/10 minutes)
a-2: Propylene-ethylene random copolymer (ethylene content = 4.0% by weight, MFR = 25 g/10 minutes)
a-3: Propylene homopolymer (ethylene content = 0% by weight, MFR = 25 g/10 minutes)
b-1: Glass fiber (16 μm in diameter)
c-1: Maleic anhydride-modified polypropylene resin (MFR = 60 g/10 minutes, the amount of maleic anhydride grafted = 0.6% by weight)

The product of Example 1, which satisfies the requirements of the present invention, is superior in creep characteristic. That is, the rupture time in the tensile creep measurement was sufficiently long.

In contrast, the products of Comparative Examples 1 and 2, in which products the ethylene contents of the propylene-based resins used do not satisfy the requirements of the present in this respect, are poor in creep characteristic. That is, the rupture time in the tensile creep measurement was short.

What is claimed is:

1. A fiber-polypropylene resin composite comprising 20-95% by weight of component (A) defined below and 5-80% by weight of component (B) which is fiber having a weight average length of 2-100 mm, provided that said contents of components (A) and (B) are based on the combined weight of components (A) and (B):
component (A): a propylene-based resin that comprises component (A-1) which is a propylene-based random copolymer obtained by polymerization of propylene and at least one kind of monomer selected from the group consisting of ethylene and α-olefin, the propylene-based resin having a content of the polymerized monomer units derived from the monomers belonging to the group consisting of ethylene and α-olefin of 0.1-3% by weight; or a modified propylene-based resin obtained by modification of the propylene-based resin with an unsaturated carboxylic acid or its derivative, provided that said content of the polymerized monomer units is based on the weight of the whole polymerized monomer units contained in the propylene-based resin.

2. A fiber-polypropylene resin composite comprising resin (D) defined below and component (B) which is fiber having a weight average length of 2-100 mm, provided that the amount of component (B) is 5-400 parts by weight based on 100 parts by weight of resin (D):
resin (D): a resin consisting of 60-99.9% by weight of component (A′) defined below and 0.1-40% by weight of component (C) which is a modified polyolefin, provided that said contents of components (A′) and (C) are based on the weight of the resin and the sum of the contents is 100% by weight;
component (A′): a propylene-based resin that comprises component (A-1) which is a propylene-based random copolymer obtained by polymerization of propylene and at least one kind of monomer selected from the group consisting of ethylene and α-olefin, the propylene-based resin having a content of the polymerized monomer units derived from the monomers belonging to the group consisting of ethylene and α-olefin of 0.1-3% by weight, provided that said content of the polymerized monomer units is based on the weight of the whole polymerized monomer units contained in the propylene-based resin.

3. A pellet made of the fiber-polypropylene resin composite according to claim 1 or 2, wherein the individual fibers constituting component (B) are arranged in parallel to one another.

4. A shaped article obtained by melt-kneading the fiber-polypropylene resin composite according to claim 1 or 2 and then shaping the resulting kneaded material, wherein the fibers derived from component (B) have a weight average length of at least 1 mm.
